(19) United States
(12) Patent Application Publication
(10) Pub. No.: US 2025/0382983 A1
(43) Pub. Date: Dec. 18, 2025

(54) Door Module Clip

(71) Applicant: Illinois Tool Works Inc., Glenview, IL (US)

(72) Inventors: Hideki Kanie, Aichi (JP); Logan Irvine, Chippewa Falls, WI (US); ZhongXin Zhang, Shanghai (CN)

(21) Appl. No.: 19/172,843

(22) Filed: Apr. 8, 2025

Related U.S. Application Data
(60) Provisional application No. 63/659,681, filed on Jun. 13, 2024.

(51) Int. Cl. F16B 5/06; B60J 5/04

(52) U.S. Cl. CPC F16B 5/0621; B60J 5/0416

(57) ABSTRACT

Described is a fastener assembly for attaching a door module having a first opening relative to a door structure having a second opening, the door module having a cabin-side surface and an exterior surface. The fastener assembly includes a clip body and an annular seal. The clip body defines a seal flange, a first body portion to pass at least partially through the first opening, and a second body portion to pass at least partially through the second opening. The first body portion is coupled to a first side of the seal flange and a second body portion coupled to a second side of the seal flange. The first body portion can include a cam feature to secure with the door module via the first opening when the clip body is rotated relative to the door module about an axis of rotation. The second body portion includes a shoulder to secure with the door structure via the second opening when the clip body is rotated relative to the door structure about the axis of rotation. The annular seal is coupled to the seal flange to form a seal between the seal flange and the door module.

### RELATED APPLICATIONS

The present application claims priority to U.S. Provisional Patent Application No. 63/659,681, filed Jun. 13, 2024, and entitled “Door Module Clip,” which is hereby incorporated by reference in its entirety.

### BACKGROUND

Automotive components necessitate fastening techniques that prioritize simplicity in manufacturing and assembly while maintaining reliability and efficiency. Vehicle doors, like those on automobiles, transition between open and closed positions and often incorporate interior controls.

A typical vehicle door includes a main frame. In some cases, there is a door module attached to the main frame, usually secured via one or more fasteners. This assembly not only mounts the module, but also seals it to the frame to prevent moisture ingress; a process that is traditionally labor-intensive. Attaching the door module to the door structure, rather than integrating them, streamlines the manufacturing process. The structure, usually metal, defines the window contour, while the module (whether metal or plastic) fits therein. This separation eases installation of components, such as window actuators, because it is simpler for the assembler, such as an OEM (original equipment manufacturer) facility, to assemble each component separately.

Nevertheless, despite existing advancements, a need exists for systems and methods that efficiently facilitate the securing of two components, such as a door module and a door structure of, for example, a motor vehicle.

### SUMMARY

The present disclosure relates generally to systems and methods that efficiently facilitate the securing of two components, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates an assembly diagrammatic view of a door structure and a door module, respectively.

FIG. 1b illustrates an assembled diagrammatic view of the door structure and the door module, respectively.

FIGS. 2a and 2b illustrate, respectively, top-side isometric assembly and assembled views of a fastening system having a clip in accordance with an aspect of this disclosure.

FIGS. 2c, 2d, and 2e illustrate isometric views of the fastening system during an example assembly process.

FIGS. 2f and 2g illustrate, respectively, cross-sectional isometric and side elevation views of the fastening system taken along cut line A-A (FIG. 2e).

FIGS. 3a and 3b illustrate, respectively, a topside isometric assembly and assembled views of a fastening system having a clip in accordance with another aspect of this disclosure.

FIGS. 3c, 3d, and 3e illustrate isometric views of the fastening system during an example assembly process.

FIGS. 3f and 3g illustrate, respectively, cross-sectional isometric and side elevation views of the fastening system taken along cut line B-B (FIG. 3e).

FIGS. 4a and 4b illustrate, respectively, topside and underside isometric assembly views of a clip and a component in accordance with yet another aspect of this disclosure.

FIGS. 4c and 4d illustrate, respectively, top, and bottom plan views of the clip of FIGS. 4a and 4b.

FIGS. 4e through 4h illustrate, respectively, first, second, third, and fourth second side elevation views of the clip of FIGS. 4a and 4b.

FIG. 4i illustrates an isometric view of a ramp that is sloped in accordance with an aspect of this disclosure.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

Prior to shipment to an assembly plant, clip assemblies are currently assembled with door modules at a door module supplier from cabin-side of the door module (e.g., as a part-in-assembly). At the assembly plant, operators push the part-in-assembly such that the clip assembly is inserted into an opening in a door structure. Once clipped in place, the clip assembly is turned to ultimately fix the door module relative to the door structure. In order to assembly clip assemblies with the door module from cabin-side surface, the opening in the door module must be sufficiently large to enable the clip assembly to pass therethrough, while also being able to secure with the door module when installed. This typically necessitates a larger opening and/or complex shapes; however, there is a desire to minimize the hole for clip assembly in the door module plate.

To address this need, disclosed are clip assemblies configured for assembly with the door module at a door module supplier from the exterior surface of the door module (the side of the door module that faces away from the cabin—i.e., opposite the cabin-side) prior to shipment to an assembly plant (e.g., as a part-in-assembly). Providing a clip assembly considered for installation from the exterior surface enables the use of smaller openings in the door module.

In one example, a fastener assembly for attaching a door module having a first opening relative to a door structure having a second opening, the door module having a cabin-side surface and an exterior surface comprises: a clip body that defines a seal flange, a first body portion configured to pass at least partially through the first opening, and a second body portion configured to pass at least partially through the second opening, wherein the first body portion is coupled to a first side of the seal flange and a second body portion coupled to a second side of the seal flange, wherein the first body portion comprises one or more cam features configured to secure with the door module via the first opening when the clip body is rotated relative to the door module about an axis of rotation, and wherein the second body portion comprises one or more shoulders configured to secure with the door structure via the second opening when the clip body is rotated relative to the door structure about the axis of rotation; and an annular seal coupled to the seal flange, wherein the annular seal is configured to form a seal between the seal flange and the door module.

In another example, a fastener assembly for attaching a first component having a first opening relative to a second component having a second opening, the first component having a cabin-side surface and an exterior surface comprises: a clip body that defines a seal flange, a first body portion configured to pass at least partially through the first opening, and a second body portion configured to pass at least partially through the second opening, wherein the first body portion is coupled to a first side of the seal flange and a second body portion coupled to a second side of the seal flange, wherein the first body portion comprises one or more cam features configured to secure with the first component via the first opening when the clip body is rotated relative to the first component about an axis of rotation, and wherein the second body portion comprises one or more shoulders configured to secure with the second component via the second opening when the clip body is rotated relative to the second component about the axis of rotation; and an annular seal coupled to the seal flange, wherein the annular seal is configured to form a seal between the seal flange and the first component.

In yet another example, a fastening system comprises: a first component having a first opening, first component having a cabin-side surface and an exterior surface; a second component having a second opening; and a fastener assembly having a clip body that defines a seal flange and an annular seal coupled to the seal flange, wherein the clip body defines a seal flange, a first body portion configured to pass at least partially through the first opening, and a second body portion configured to pass at least partially through the second opening, wherein the first body portion is coupled to a first side of the seal flange and second body portion coupled to a second side of the seal flange, wherein the first body portion comprises one or more cam features configured to secure with the first component via the first opening when the clip body is rotated relative to the first component about an axis of rotation, wherein the second body portion comprises one or more shoulders configured to secure with the second component via the second opening when the clip body is rotated relative to the second component about the axis of rotation, and wherein the annular seal is configured to form a seal between the seal flange and the first component.

In some examples, the first body portion comprises one or more resilient latches configured to latch to the first opening when the first body portion inserted at least partially through the first opening.

In some examples, the annular seal is configured to form a seal between the seal flange and the exterior surface of the first component.

In some examples, the seal flange comprises a plurality of openings configured to increase attachment with the annular seal.

In some examples, the first body portion comprises a recess configured to receive at least a portion of a tool. The recess can be hex-shaped.

In some examples, the first body portion comprises a head section that is hex-shaped and configured to receive at least a portion of a tool.

In some examples, the second body portion comprises an arm having a button positioned at a distal end thereof. The button can be configured to engage the first component. For example, the button can be configured to engage the first component via one or more features formed in or on the exterior surface of the first component.

In some examples, the first body portion comprises a set of fingers configured to engage the first opening.

In some examples, the one or more features comprise a pocket or a ramp.

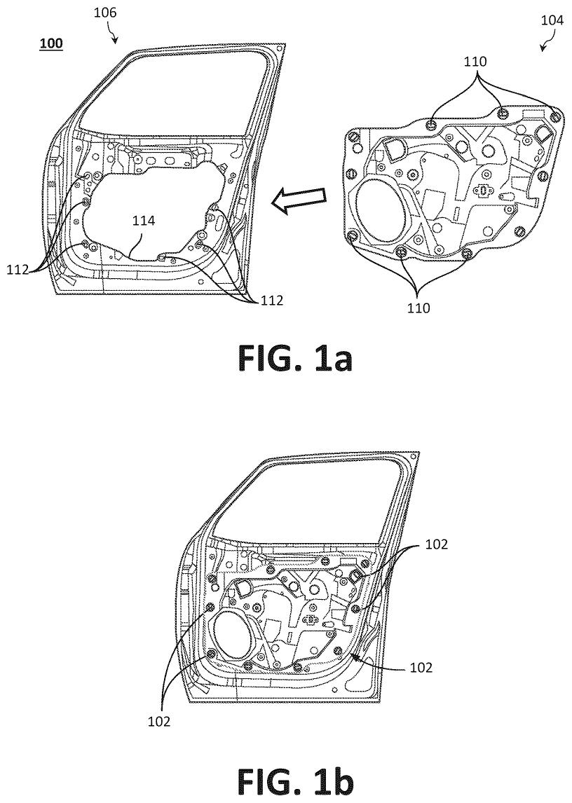

FIGS. 1a and 1b illustrate, respectively, assembly and assembled diagrammatic views of a vehicle door 100 having a first component 104 and a second component 106. The first component 104 and the second component 106 may be, for example, automotive panels or other automotive components. In the illustrated example, the first component 104 is a door module and the second component 106 is a door structure that defines a cavity 114 configured to receive the door module. As illustrated, the door structure can include an upper part forming a frame designed to extend around a side window of the vehicle, and a lower part including the cavity 114. The cavity 114 is designed to be filled at least partially by the first component 104 (e.g., door module).

A plurality of fastening assemblies is configured to join and secure the second component 106 relative to the first component 104. To facilitate attachment via the fastener assembly 202, each of the first component 104 and the second component 106 includes one or more engagement features, such as a first opening 110 and a second opening 112. For example, the first component 104 is illustrated as having a plurality of first openings 110 formed therein and the second component 106 is illustrated as having a plurality of second openings 112 formed therein.

Depending on the application, one or both of the first component 104 and/or the second component 106 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof.

In the illustrated example, the first component 104 and the second component 106 are joined at each of a plurality of attachment points via a fastener assembly (example of which will be discussed) that cooperates with the corresponding first opening 110 and second opening 112 to define a fastening system 102. Each of the first opening 110 and the second opening 112 is sized and shaped to receive a portion of the fastener assembly. The first opening 110 and the second opening 112 can be formed in the respective first component 104 or second component 106 during manufacturing thereof or added post-manufacture through a mechanical process (e.g., drilling, cutting, carving, etc.). After the first component 104 and the second component 106 are assembled, as illustrated in FIG. 1b, the first component 104 is covered at least partially by the second component 106.

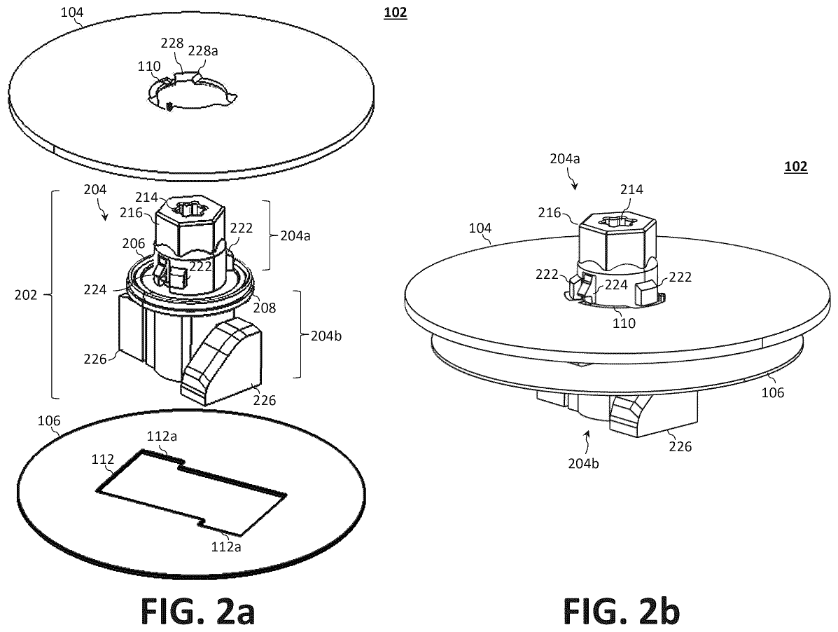

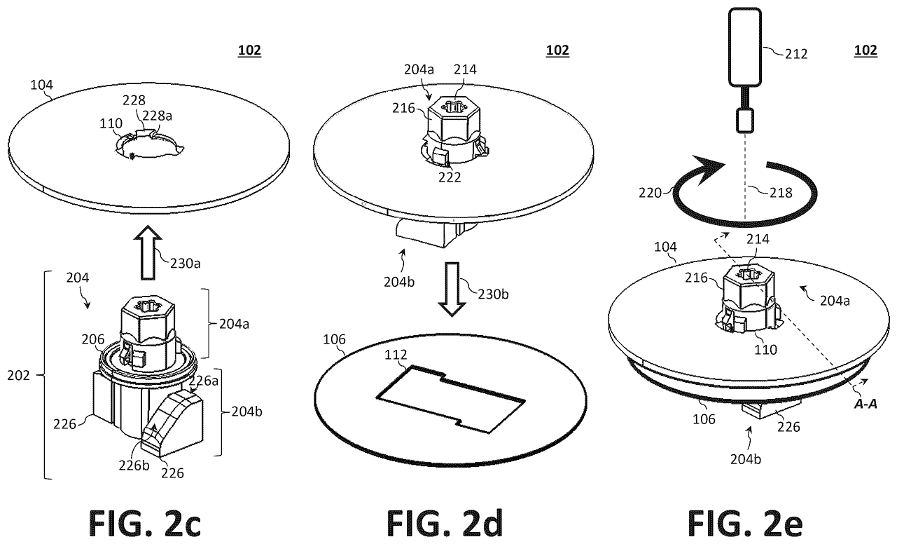

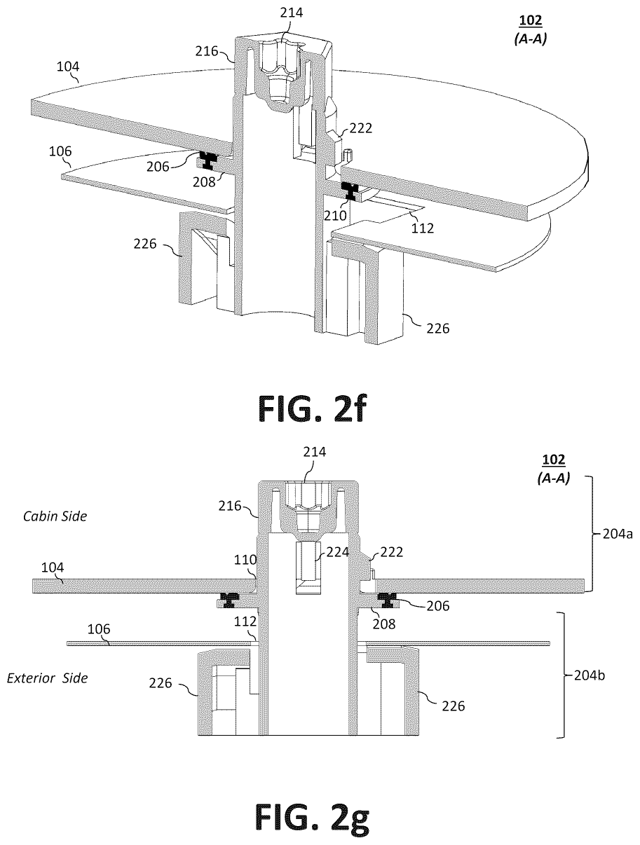

FIGS. 2a and 2b illustrate, respectively, topside isometric assembly and assembled views of a fastening system 102 having a fastener assembly 202 in accordance with an aspect of this disclosure, while FIGS. 2c, 2d, and 2e illustrate isometric views of the fastening system 102 during an example assembly process. FIGS. 2f and 2g illustrate, respectively, cross-sectional isometric and side elevation views of the fastening system 102 taken along cut line A-A (FIG. 2e). In this example, the fastening system 102 includes the fastener assembly 202, the first opening 110, and the second opening 112.

The fastener assembly 202 generally comprises a clip body 204 (e.g., a rigid structure) and an annular seal 206 (e.g., a pliable structure). The clip body 204 generally defines a first body portion 204a configured to engage the first component 104 and a second body portion 204b configured to engage the second component 106. A seal flange 208 is positioned between the first body portion 204a and the second body portion 204b. In the illustrated example, the seal flange 208 is positioned at an approximate mid-point between the distal ends of the first body portion 204a and the second body portion 204b. In some examples, the first body portion 204a and the second body portion 204b generally resemble posts having a cross-sectional profile that, at one or more positions along its length, is one of more of circular, quadrilateral, hexagonal, or the like.

In one example, portions of the clip body 204 (including the seal flange 208) are formed from a rigid material and as a unitary structure. The clip body 204 can be made from various materials, including synthetic or semi-synthetic polymers (e.g., plastics, such as acrylonitrile butadiene styrene (ABS) and polyvinyl chloride (PVC), etc.), composite materials (e.g., fiber glass), metal (or a metal alloy), or a combination thereof. In one example, the clip body 204 can be fabricated via mold tooling and a plastic-injection molding process. In another example, the clip body 204 can be a printed thermoplastic material component that can be printed with great accuracy and with numerous details, which is particularly advantageous, for example, in creating components requiring complex and/or precise features. The annular seal 206 may be fabricated from a foam material, thermoplastic, rubber materials, etc. Example thermoplastics include, inter alia, polyethene (PE), polyvinyl chloride (PVC), etc. In another example, the annular seal 206 can be formed from a die cutting process and positioned on the seal flange 208 and around the first body portion 204a. By way of illustration, the annular seal 206 can be formed separately and overlaid, adhered, or otherwise positioned on the seal flange 208.

Additive manufacturing techniques obviate the need for mold tooling typically associated with plastic injection molding, thereby lowering up-front manufacturing costs, which is particularly advantageous in low-volume productions. In some examples, components of the fastener assembly 202 may be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process. Therefore, in one example, the seal flange 208 can be a rigid plastic structure and the annular seal 206 is a softer material that is over-molded onto the seal flange 208 to form the fastener assembly 202.

The annular seal 206 assists in providing a seal between the seal flange 208 and the first component 104. The annular seal 206 limits water and/or debris from egressing through the fastener assembly 202. As illustrated, the annular seal 206 is positioned on the top side of the seal flange 208 (i.e., adjacent the proximal/base end of the first body portion 204a) such that it abuts the exterior dies of the first component 104 when assembled. This configuration allows for assembly of the fastener assembly 202 with the first component 104 from the exterior surface 104b of the first component 104.

The seal flange 208, which is illustrated as a generally annular plate (e.g., a disk), is configured to retain, support, and secure an annular seal 206. The seal flange 208 can include a plurality of openings 210 to increase attachment and/or surface area contact with the annular seal 206. For example, portions of the annular seal 206 can protrude, flow, or otherwise pass through and/or into the openings 210 to increase attachment with the seal flange 208.

Each of the first body portion 204a and the second body portion 204b comprises one or more features for manipulation thereof and for securing with its respective second component 106 and/or first component 104. The first body portion 204a includes one or more manipulable features configured to be manipulated by hand or to engage a tool 212 (e.g., a socket, screw-driver, etc.) and one or more engagement features configured to engage the first component 104, while the second body portion 204b includes one or more engagement features configured to engage the second component 106.

The illustrated first body portion 204a, for instance, includes a hex-shaped head section 216 and a recess 214 that is hex-shaped and configured to receive a tool 212. While the head section 216 and the recess 214 are illustrated as hex-shaped (i.e., 6-sided), other shapes are contemplated depending on whether it is hand-manipulated and/or by the type of tool; including, for example, knobs, triangular, square, star, X-shaped, D-shaped, etc.

During assembly, with reference to FIGS. 2c through 2e, the first body portion 204a of the clip body 204 is inserted into the first opening 110 from the exterior surface 104b of the first component 104 (the side of the first component 104 that faces away from the cabin—i.e., opposite the cabin-side) as indicated by arrow 230a. The second body portion 204b of the clip body 204 (as a part-in-assembly, for example) is then inserted into the second opening 112 as indicated by arrow 230b. Once in place, the clip body 204 is rotated (from the cabin-side surface 104a) about the central axis 218 as indicated by arrow 220.

The operator can, for example, engage and rotate the first body portion 204a (and, thus, rotate the fastener assembly 202) about the central axis 218 as indicated by arrow 220 (e.g., via the tool 212) and relative to the first component 104 via one or both of the hex-shaped head section 216 and the hex-shaped recess 214. As the fastener assembly 202 rotates about the central axis 218, the one or more engagement features engage and secure the first component 104 and the second component 106. The illustrated first body portion 204a, for instance, includes one or more cam features 222 and/or resilient latches 224. Each of the one or more cam features 222 is configured to secured the first component 104 through a rotational movement, while the resilient latches 224 are configured to snap and retain the first component 104 when the fastener assembly 202 is inserted into the first opening 110 (e.g., forming a part-in-assembly). The resilient latch 224 can be formed in a thickness of the first body portion 204a. The illustrated resilient latch includes a tab that comprises a first end connected to the first body portion 204a and a free second end configured to secure with the first component 104.

In the illustrated example, the first body portion 204a comprises three cam features 222 and three resilient latches 224 distributed about the central axis 218. Specifically, the three cam features 222 are distributed evenly (i.e., 120 degrees) about the central axis 218 and the three resilient latches 224 are distributed evenly (i.e., 120 degrees) about the central axis 218. Each of the cam features 222 offset about the central axis 218 relative adjacent resilient latches 224. While three of each are illustrated, additional or fewer cam features 222 and resilient latches 224 may be employed depending on the number of desired attachment points with the first component 104 and the amount of turning desired to connect and disconnect the fastener assembly 202 relative to the first component 104.

The second body portion 204b of the fastener assembly 202 includes or defines two shoulders 226. In the illustrated example, the two shoulders 226 are transverse and diametrically opposite one another relative to the central axis 218. In the example shown, each shoulder 226 is shaped as a generally truncated rectangular prism. That is, each shoulder 226 is a rectangular prism having a substantially flat upper surface 226a, but cut via transverse plane to define an angled surface 226b. The angled surface 226b serves as a cam surface or ramp surface to guide the second component 106 closer to the first component 104 one another when rotated about the central axis 218. That is, the angled surface 226b is configured to cooperate with a complementary surface of the second component 106 when the fastener assembly 202 rotates. The direction of rotation of the 108 is shown by arrow 220.

In some examples, the fastener assembly 202 can be inserted into and secured relative to the first opening 110 via the clip assemblies 108 to form a part-in-assembly with the first component 104. The part-in-assembly can then be joined with the second component 106 by rotating the fastener assembly 202 about the central axis 218 to secure with the second component 106 (via the one or more cam features 222) and with the second component 106 (via the shoulders 226).

The first opening 110 and the second opening 112 are configured to receive and engage a portion of the clip body 204. In the illustrated example, the second opening 112 is generally rectangular and the first opening 110 is generally circular. For example, the first opening 110 is generally circular and configured to receive and accommodate the cross-sectional profile of the first body portion 204a and shaped to correspond with the base/proximal end of the first body portion 204a (thus minimizing size and gaps). Similarly, the second opening 112 is generally rectangular to receive and accommodate the cross-sectional profile of the second body portion 204b, but with additional notches 112a to accommodate the shoulders 226,

The first opening 110 and the second opening 112 may each further comprise or define one or more engagement features configure to engage and secure the clip body 204. For example, the illustrated first opening 110 defines one or more notches 228, each notch 228 having a ramped portion 228a (e.g., a chamfer). During and post assembly, the one or more notches 228 are configured to engage one more features on the clip body 204 (e.g., cam features 222).

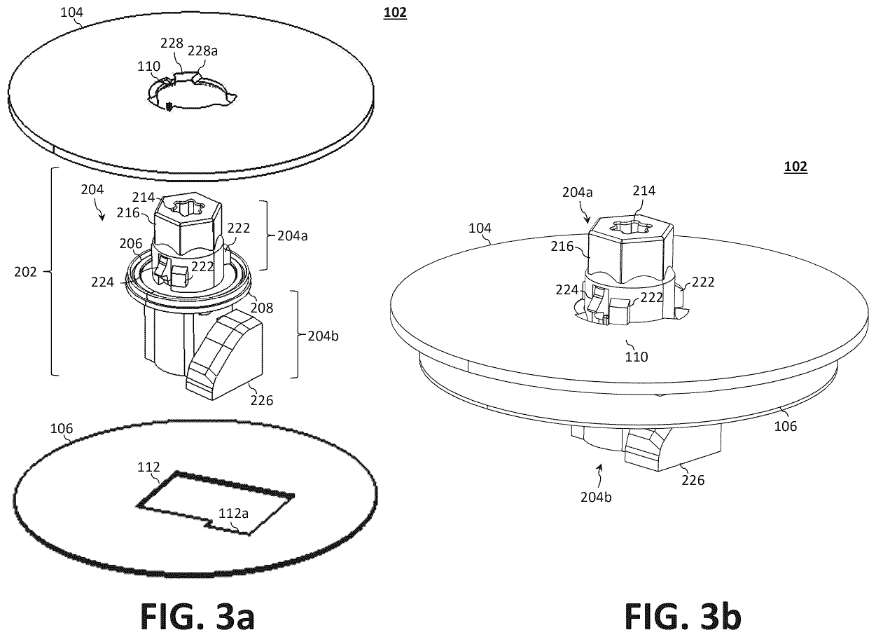

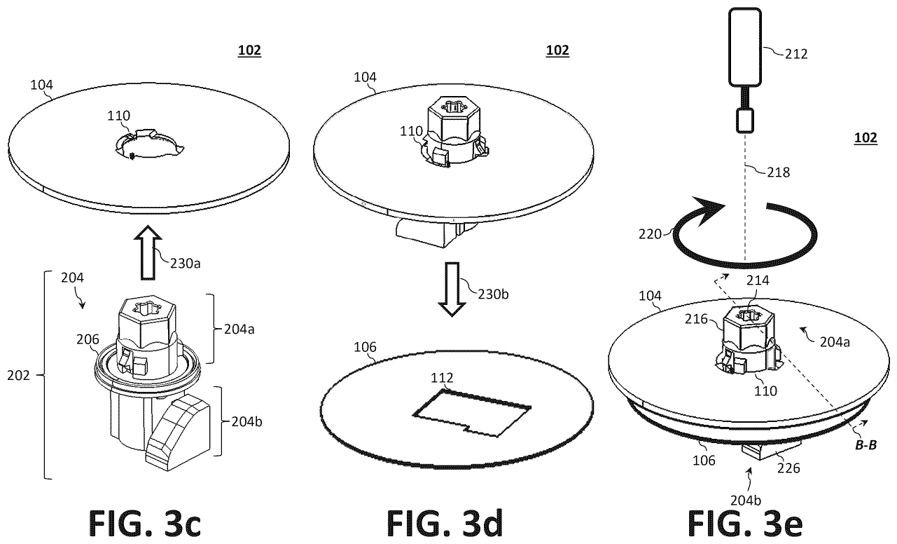

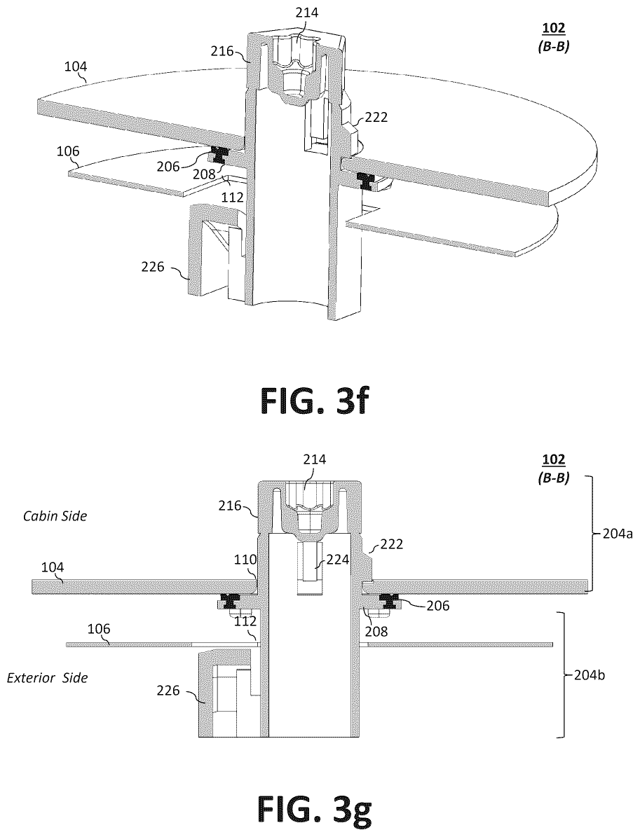

FIGS. 3a and 3b illustrate, respectively, a top-side isometric assembly and assembled views of a fastening system 102 having a fastener assembly 202 in accordance with another aspect of this disclosure, while FIGS. 3c, 3d, and 3e illustrate isometric views of the fastening system 102 during an example assembly process. FIGS. 3f and 3g illustrate, respectively, cross-sectional isometric and side elevation views of the fastening system 102 taken along cut line B-B (FIG. 3e).

The fastener assembly 202 of FIGS. 3a through 3e is substantially identical to the fastener assembly 202 of FIGS. 2a through 2e except that the second body portion 204b includes a single shoulder 226 rather than a pair of diametrically opposed shoulders. Using a single shoulder 226 obviates the need for two notices 112a, thus reducing the side of the second opening 112 and serving as a poka-yoke to ensure a specific orientation during assembly.

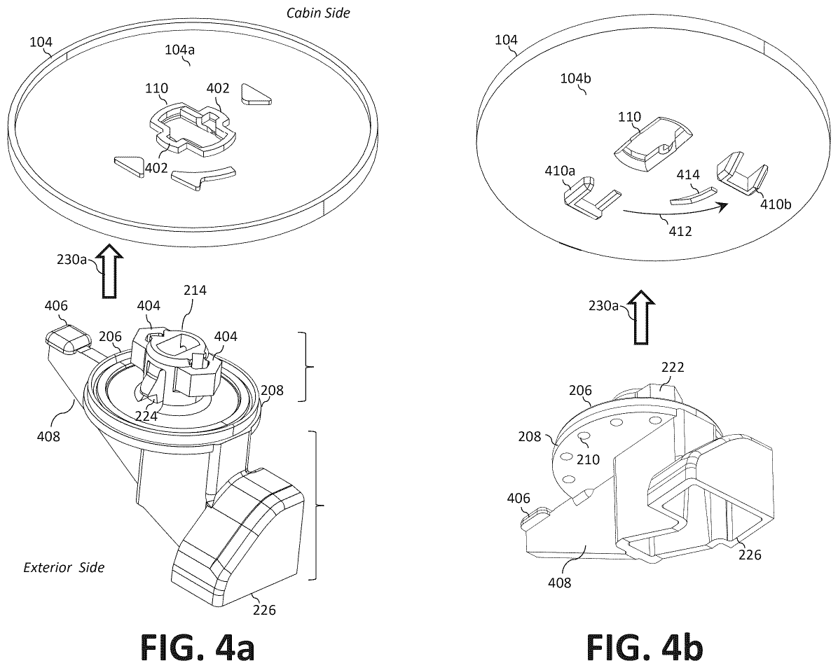

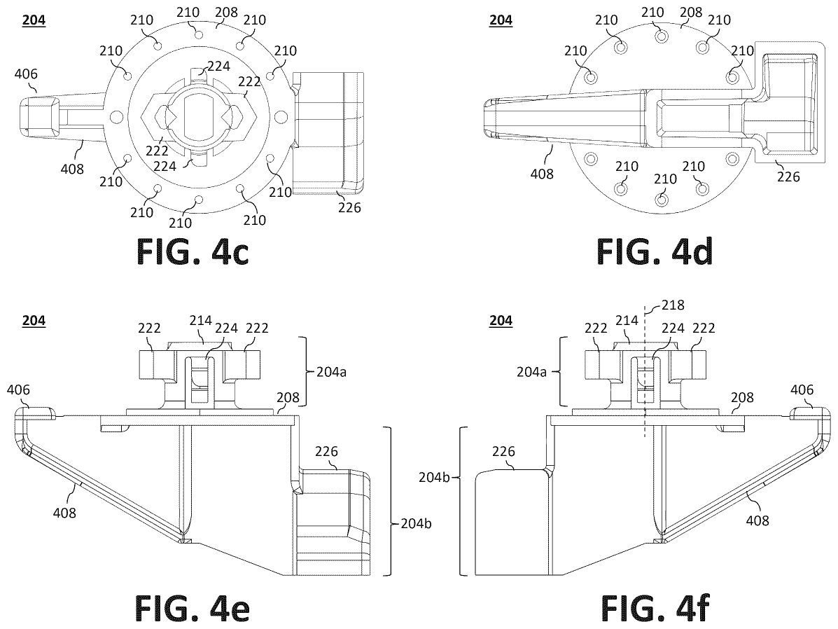

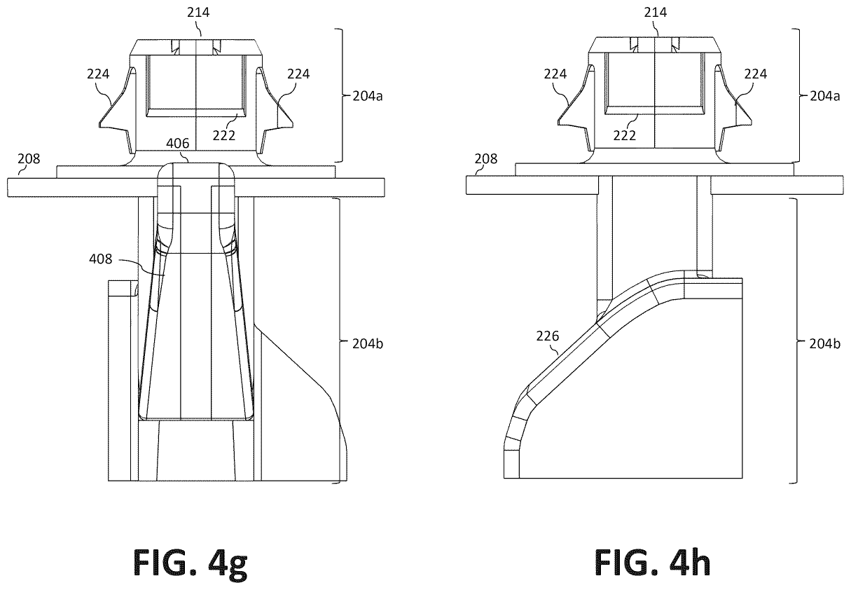

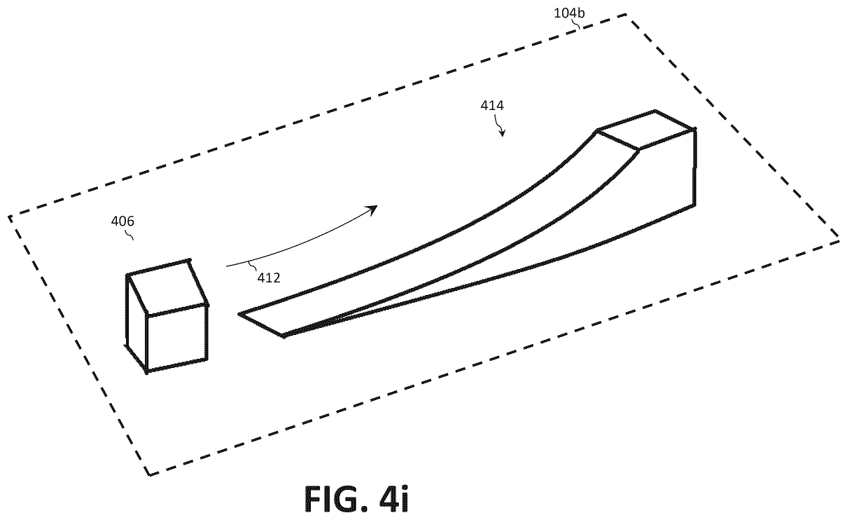

FIGS. 4a and 4b illustrate, respectively, topside and underside isometric assembly views of a clip body 204 and a component (illustrated as the first component 104) in accordance with yet another aspect of this disclosure. The second component 106 is omitted from FIGS. 4a and 4b to better illustrate the components of the clip body 204. FIGS. 4c and 4d illustrate, respectively, top, and bottom plan views of the clip body 204 of FIGS. 4a and 4b, while FIGS. 4e through 4h illustrate, respectively, first, second, third, and fourth second side elevation views of the clip body 204 of FIGS. 4a and 4b. The annular seal 206 is omitted from the views to better illustrate the components of the clip body 204.

The fastener assembly 202 depicted in FIGS. 4a through 4h is largely similar to the fastener assembly 202 shown in FIGS. 2a through 2e in terms of its core components and installation method, with certain exceptions and modifications, as summarized below. In this example, the first body portion 204a of the fastener assembly 202 is configured to engage a first opening 110 that is shaped as an elongated slot with a set of clip recesses 402.

As best illustrated in FIG. 4a, the clip recesses 402 are positioned on the major sides of the elongated slot. To that end, the first body portion 204a comprises a set of resilient latches 224 and a set of fingers 404. The set of fingers 404 are sized and shaped to pass through the slot as indicated by arrow 230a in a first orientation until the resilient latches 224 snap the fastener assembly 202 to the first component via the clip recesses 402 to form a part in assembly. The part-in-assembly can then be assembled with a second component 106 as describe in connection with the prior examples, but, in this case, the fastener assembly 202 rotated by a quarter turn (i.e., 90 degrees) to secure the fastener assembly 202 with the first component 104 via the set of fingers 404.

The second body portion 204b comprises a shoulder 226 and an arm 408 having a button 406 positioned at a distal end thereof. In the illustrated example, the arm 408 is cantilevered away from the central axis 218. The button 406 is oriented to abut the exterior surface 104b of the first component 104 when assembled. The button 406 is configured to, for example, engage the first component 104 via one or more features formed in or on the first component 104.

As illustrated, the exterior surface 104b of the first component 104 may define one or more pockets 410a, 410b that are configured to receive and/or abut the button 406 depending on an axial position of the fastener assembly 202 relative to the first component 104. For example, when shipping the first component 104 with the fastener assembly 202 as a PIA to an assembler (e.g., an OEM facility), the fastener assembly 202 may be oriented in a first position (e.g., a shipping or PIA position) whereby the button 406 is positioned in a first pocket 410a. Once the second body portion 204b of the fastener assembly 202 (when coupled with the first component 104) is passed through a second opening of a second component, the fastener assembly 202 is rotated by the quarter turn (i.e., 90 degrees) to a second position (e.g., a fixed or locked position). Rotating the fastener assembly 202 from the first position to the second position causes the button 406 to travel from the first pocket 410a to the second pocket 410b as indicated by arrow 412. Once in the second position, the button 406 abuts the second pocket 410b. To guide and maintain the button in this position, the exterior surface 104b of the first component 104 may define one or more ramps 414 to bias the button 406 away from the exterior surface 104b and/or against the second pocket 410b. In addition to increasing stability between the first component 104 and the fastener assembly 202, the one or more pockets 410 and/or the ramp 414 can provide tactile feedback to the operator/user and prevent the fastener assembly 202 from being rotated too little (i.e., less than a quarter turn) or too far (i.e., beyond a quarter turn).

FIG. 4i illustrates an isometric view of an example ramp 414 that is sloped in accordance with an aspect of this disclosure. The slope of the ramp 414 assists in compressing the annular seal 206 during installation. In some cases, compressing the annular seal 206 can be challenging when rotating the fastener assembly 202 from the first position to the second position. This rotation causes the button 406 to move from the first pocket 410a to the second pocket 410b, as indicated by arrow 412. The slope is designed without sharp edges to facilitate the compression of the annular seal 206. The slope of the ramp 414 biases the fastener assembly 202 upwards during rotation, ensuring a smoother and more effective compression process.

While the present method and/or system have been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A fastener assembly for attaching a first component having a first opening relative to a second component having a second opening, the fastener assembly comprising:
a clip body that defines a seal flange, a first body portion configured to pass at least partially through the first opening, and a second body portion configured to pass at least partially through the second opening,
wherein the first body portion is coupled to a first side of the seal flange and a second body portion is coupled to a second side of the seal flange,
wherein the first body portion comprises one or more cam features configured to secure with the first component via the first opening when the clip body is rotated relative to the first component about an axis of rotation, and
wherein the second body portion comprises one or more shoulders configured to secure with the second component via the second opening when the clip body is rotated relative to the second component about the axis of rotation; and
an annular seal coupled to the seal flange, wherein the annular seal is configured to form a seal between the seal flange and the first component.

2. The fastener assembly of claim 1, wherein the first body portion comprises one or more resilient latches configured to latch to the first opening when the first body portion inserted at least partially through the first opening.

3. The fastener assembly of claim 1, wherein the first component includes an interior surface and an exterior surface, and wherein the annular seal is configured to form a seal between the seal flange and the exterior surface of the first component.

4. The fastener assembly of claim 1, wherein the seal flange comprises a plurality of openings configured to increase attachment with the annular seal.

5. The fastener assembly of claim 1, wherein the first body portion comprises a recess configured to receive at least a portion of a tool.

6. The fastener assembly of claim 5, wherein the recess that is hex-shaped.

7. The fastener assembly of claim 1, wherein the first body portion comprises a head section that is hex-shaped and configured to receive at least a portion of a tool.

8. The fastener assembly of claim 1, wherein the second body portion comprises an arm having a button positioned at a distal end thereof.

9. The fastener assembly of claim 8, wherein the button is configured to engage the first component.

10. The fastener assembly of claim 9, wherein the first component includes an interior surface and an exterior surface, and wherein the button is configured to engage the first component via one or more features formed in or on the exterior surface of the first component.

11. The fastener assembly of claim 1, wherein the first body portion comprises a set of fingers configured to engage the first opening.

12. The fastener assembly of claim 10, wherein the one or more features comprises a pocket or a ramp.

13. A fastener assembly for attaching a door module having a first opening relative to a door structure having a second opening, the door module having a cabin-side surface and an exterior surface, the fastener assembly comprising:
a clip body that defines a seal flange, a first body portion configured to pass at least partially through the first opening, and a second body portion configured to pass at least partially through the second opening,
wherein the first body portion is coupled to a first side of the seal flange and a second body portion is coupled to a second side of the seal flange,
wherein the first body portion comprises one or more cam features configured to secure with the door module via the first opening when the clip body is rotated relative to the door module about an axis of rotation, and
wherein the second body portion comprises one or more shoulders configured to secure with the door structure via the second opening when the clip body is rotated relative to the door structure about the axis of rotation; and
an annular seal coupled to the seal flange, wherein the annular seal is configured to form a seal between the seal flange and the door module.

14. The fastener assembly of claim 13, wherein the first body portion comprises one or more resilient latches configured to latch to the first opening when the first body portion inserted at least partially through the first opening.

15. The fastener assembly of claim 13, wherein the annular seal is configured to form a seal between the seal flange and the exterior surface of the door module.

16. The fastener assembly of claim 13, wherein the seal flange comprises a plurality of openings configured to increase attachment with the annular seal.

17. The fastener assembly of claim 13, wherein the first body portion comprises a recess configured to receive at least a portion of a tool.

18. The fastener assembly of claim 13, wherein the second body portion comprises an arm having a button positioned at a distal end thereof that is configured to engage the door module.

19. A fastening system comprising:
a first component having a first opening, first component having a cabin-side surface and an exterior surface;
a second component having a second opening; and
a fastener assembly having a clip body that defines a seal flange, and an annular seal coupled to the seal flange,
wherein the clip body defines a seal flange, a first body portion configured to pass at least partially through the first opening, and a second body portion configured to pass at least partially through the second opening,
wherein the first body portion is coupled to a first side of the seal flange and second body portion is coupled to a second side of the seal flange,
wherein the first body portion comprises one or more cam features configured to secure with the first component via the first opening when the clip body is rotated relative to the first component about an axis of rotation,
wherein the second body portion comprises one or more shoulders configured to secure with the second component via the second opening when the clip body is rotated relative to the second component about the axis of rotation, and
wherein the annular seal is configured to form a seal between the seal flange and the first component.

20. The fastening system of claim 19, wherein the first body portion comprises one or more resilient latches configured to latch to the first opening when the first body portion inserted at least partially through the first opening.
